(19) United States
(12) Patent Application Publication
(10) Pub. No.: US 2026/0088670 A1
(43) Pub. Date: Mar. 26, 2026

(54) HIGH-SPEED ENGINE FOR A MOTOR VEHICLE

(71) Applicant: Dr. Ing. h.c. F. Porsche Aktiengesellschaft, Stuttgart (DE)

(72) Inventor: Maximilian CLAUER, Weissach (DE)

(21) Appl. No.: 19/329,595

(22) Filed: Sep. 16, 2025

(30) Foreign Application Priority Data
Sep. 25, 2024 (DE) 10 2024 127 773.4

(51) Int. Cl. H02K 1/279; H02K 7/00

(52) U.S. Cl. CPC H02K 1/279; H02K 7/006; H02K 2213/03

(57) ABSTRACT

A high-speed engine for a motor vehicle includes a stator including a stator yoke and a plurality of stator teeth being connected to the stator yoke in a force-fitting and/or form-fitting manner; and a rotor mounted rotatably relative to the stator along an axis, the rotor including layered sheets in the axial direction, which form a laminated core. The laminated core includes at least two receiving spaces for receiving permanent magnets in a radial direction relative to an axis. A respective permanent magnet is arranged in a respective receiving space. The respective permanent magnet is configured to be inserted in a force-fitting manner in the respective receiving space. The laminated core with the permanent magnets has a circular outer contour in the radial direction relative to the axis. The rotor is enclosed by a retaining band for fixing the permanent magnets in the laminated core.

### CROSS REFERENCE TO RELATED APPLICATIONS

This application claims benefit to German Patent Application No. DE 10 2024 127 773.4, filed on Sep. 25, 2024, which is hereby incorporated by reference herein.

### FIELD

The present disclosure relates to a high-speed engine for a motor vehicle.

### BACKGROUND

In electrified vehicles, high-speed engines play a decisive role due to their many advantages, which make a significant contribution to improving drive technology. These engines are characterized by a high power density, enabling them to deliver more power per kilogram of weight, which can significantly increase the efficiency and performance of the vehicles. The higher speeds also mean that the engines can be designed to be more compact and lighter, which reduces the overall weight of the vehicle and thus improves its range. High-speed engines also make it possible to dispense with extensive transmission systems in certain design concepts, which further reduces vehicle weight and improves mechanical efficiency.

The efficient operation of these engines also reduces the need for complex thermal management systems, which in turn lowers the vehicle weight. Their compact design offers more flexibility for integration into different vehicle platforms, enabling innovative and diverse vehicle designs. Overall, high-speed engines contribute significantly to increasing the efficiency, power-to-weight ratio, and overall performance of electric drive systems, resulting in better performance and longer range of modern electric vehicles.

### SUMMARY

In an embodiment, the present disclosure provides a high-speed engine for a motor vehicle. The high-speed engine includes a stator including a stator yoke and a plurality of stator teeth, the plurality of stator teeth being connected to the stator yoke in a force-fitting and/or form-fitting manner; and a rotor mounted rotatably relative to the stator along an axis, the rotor including layered sheets in the axial direction, which form a laminated core. The laminated core includes at least two receiving spaces for receiving permanent magnets in a radial direction relative to an axis. A respective permanent magnet of the permanent magnets is arranged in a respective receiving space of the at least two receiving spaces. The respective permanent magnet is configured to be inserted in a force-fitting manner in the respective receiving space. The laminated core with the permanent magnets has a circular outer contour in the radial direction relative to the axis. The rotor is enclosed by a retaining band for fixing the permanent magnets in the laminated core.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a high-speed engine for a motor vehicle according to an embodiment of the invention; and

FIG. 2 shows a permanent magnet with a circular sector-like contour according to an embodiment of the invention.

### DETAILED DESCRIPTION

Embodiments of the present disclosure provide an improved electric engine in terms of improved torque and power density.

According to embodiments of the present disclosure, a high-speed engine for a motor vehicle and a motor vehicle with a high-speed engine are provided.

Embodiments of the present inventions relate to a high-speed engine for a motor vehicle, comprising a stator and a rotor mounted rotatably relative to the stator along an axis, wherein the stator comprises a stator yoke and a plurality of stator teeth, wherein the stator teeth are connected to the stator yoke in a force-fitting and/or form-fitting manner, wherein the rotor comprises layered sheets in the axial direction, which form a laminated core, the laminated core comprising at least two receiving spaces in the radial direction relative to the axis, a permanent magnet being arranged in each receiving space, the respective permanent magnet being arranged in the respective receiving space in a force-fitting manner, wherein the laminated core with the permanent magnets has a circular outer contour in the radial direction to the axis, the rotor being enclosed by a retaining band for fixing the permanent magnets in the laminated core.

In an implementation, the stator can be made of or comprise electrical sheet.

Electrical sheet, also known as dynamo sheet, is a specially developed ferromagnetic material that can be used in electrical engineering to manufacture cores in electrical engines. Electrical sheet can consist of or include silicon-iron alloys. These alloys can comprise special magnetic properties in order to minimize energy losses due to eddy currents and hysteresis. Properties of electrical sheet can include high magnetic permeability, which can ensure that the material can be easily magnetized and has low hysteresis losses. This means that little energy is converted into heat during remagnetization processes. Electrical sheet can also comprise low eddy current losses, which can be achieved through a special alloy and/or a thin sheet thickness and/or possible electrical insulation between the individual sheets of the laminated core. Electrical sheet can be produced in various shapes and qualities to meet the specific requirements of each application. It can be supplied as cold-rolled, non-grain-oriented (NGO), and grain-oriented (GO) electrical sheet.

In an implementation, windings can be inserted between the stator teeth of the stator to generate a rotating magnetic field. The windings can be formed from continuous conductors that comprise either a rectangular or a round cross-sectional profile. These can also be described as so-called continuous shaft windings. Here, the continuous shaft winding is inserted radially from the outside between the plurality of stator teeth and joined axially with the stator yoke in a force-fitting and/or form-fitting manner.

In an exemplary implementation, the conductors of the continuous shaft winding comprise cavities through which a fluid or gas can flow and thus a high cooling capacity can be realized due to the high heat transfer between the conductors and the fluid or gas. The conductors can be made of or comprise an electrically conductive material such as copper or aluminum.

In an implementation, the stator teeth can be made of cobalt-iron or comprise cobalt-iron. As a result, the magnetic permeability can be increased and a higher magnetic flux can be conducted, which means that more electromagnetic torque can be generated in the same installation space of the engine.

In an implementation, the stator yoke is made of cobalt iron or comprises cobalt iron, which can further increase the electromagnetic torque.

Permanent magnets force-fitted into the receiving spaces of the laminated core can have several advantages. Reduced magnetic flux leakage can improve the performance (especially the electromagnetic torque) and efficiency of the high-speed engine.

In connection with the insertion of the permanent magnets into the receiving spaces of the rotor or the rotor laminated core, the term “force-fitting manner” refers to the way in which the magnets are secured in the rotor or the laminated core, which is ensured by a retaining band with an undersize.

The shape of the magnets and the receiving spaces is designed so that they interlock and form a snug fit and the magnets are prevented from moving or slipping by the retaining band.

An additional significant advantage of this arrangement can be the increased mechanical stability of the permanent magnets, as the permanent magnets are securely integrated into the rotor or the laminated core, which prevents the permanent magnets from slipping or falling out at high speeds. This can increase the mechanical integrity of the entire assembly.

In addition, the exact positioning of the magnets allows the magnetic field to be optimally generated and utilized, which can increase the efficiency of the high-speed engine.

The force-fitted insert reduces the magnetic leakage flux within the rotor laminated core, which can lead to reduced magnetic losses and thus to higher efficiency of the high-speed engine.

A further advantage can be the reduction of vibrations and associated noise, as the force-fit fixing of the magnets reduces imbalance and can ensure quieter operation with a reduced rolling bearing load on the high-speed engine.

Another practical advantage can be the reduced assembly effort, as the force-fitted insert of the permanent magnets into the laminated core simplifies and speeds up the assembly process.

The axis of the high-speed engine is the imaginary line around which all rotating parts of the high-speed engine rotate, such as the rotor, including the laminated core, the permanent magnets, and the retaining band.

Radial to the axis refers to a direction that runs outwards or inwards from the axis. In relation to the axis, radial means that the movement or arrangement is perpendicular to the axis, i.e., along a line that starts from the center of the axis.

Axial to the axis refers to a direction along the axis. In contrast to “radial,” which points away from or towards the axis, “axial” describes movements, forces, or arrangements that run parallel to the axis.

In an implementation, the retaining band is designed as a carbon fiber bandage.

In an implementation, the fiber direction of the carbon fiber bandage extends radially around the rotor.

A significant advantage of using the carbon fiber bandage in the high-speed engine for fastening the permanent magnets in the laminated core may lie in the outstanding mechanical properties of the carbon fibers. These materials are characterized by their exceptionally high tensile strength and rigidity, which enables them to withstand high mechanical loads. This can be particularly important in a high-speed engine, as high centrifugal forces act here, which must retain the permanent magnets securely in place.

In an implementation, the rotor comprises 4 or 6 or 8 receiving spaces, each for receiving a permanent magnet. The number of poles or the number of pool pairs of the electrical engine can be determined by the number of receiving spaces.

The number of pole pairs of the high-speed engine refers to the number of magnetic poles, more precisely north and south pole pairs, which are present on the rotor of the high-speed engine. This parameter is used for determining the relationship between the speed of the rotor and the electrical frequency of the generated or applied electrical voltage. In other words, a pair of poles consists of a north pole and a south pole. The number of pole pairs is the total number of poles divided by two. For example, an engine with four magnetic poles (two north poles and two south poles) has a number of pole pairs of two. The number of pole pairs has a significant influence on the operating characteristics of the engine and is directly related to the synchronous speed of the high-speed engine. For example, a number of pole pairs of two, i.e., a number of poles of 4, corresponds to a number of 4 receiving spaces in the laminated core.

In an implementation, the high-speed engine is designed as a permanent magnet synchronous engine. The permanent magnet synchronous engine (PMSM) is a special type of synchronous engine in which the magnetic field in the rotor can be generated by permanent magnets. This design can have several advantages, such as higher efficiency, lower losses, and a more compact design.

In an implementation, the position of the receiving space on the rotor, such as on the laminated core, can be calculated using the equation,

$${θ}_{n} = \frac{360 °}{2 \cdot p} n$$

where p corresponds to a pole pair number of the high-speed engine and thus 2*p corresponds to the pole number, n to the consecutive number of the receiving space and θ_n to the angular position in degrees of the respective receiving space as a function of n.

In an implementation, the respective permanent magnet is designed as a circular sector or as a triangle.

The circular sector is a partial area of a circular surface that is delimited by a first radius and a second radius and the circular arc between them. The shape of a circular sector is defined by the center of the circle and two points on the circumference of the circle. The angle included between the two radii of the circular sector in the center of the circle is called the center angle or central angle and this angle is measured in degrees (°) or radians (rad). The two distances that run from the center of the circle to two different points on the circumference are the radii that delimit the circular sector. The part of the circumference of the circle that lies between the two points on the circle and connects the two radii is referred to as the circular arc of the circular sector. In an advantageous further embodiment, the first radius and the second radius can be identical.

In an implementation, the receiving space in the laminated core has an opening angle which corresponds to the center angle of the associated permanent magnet, which is inserted into the respective receiving space.

In an implementation, a radius of the circular arc of the circular sector corresponds to a radius of the rotor. The radius of the circular arc is not related to the circular sector, but to the axis of the high-speed engine. The radius of the circular sector, i.e., the respective permanent magnet, therefore does not have to correspond to the radius of the rotor.

The respective permanent magnet fits into the laminated core, such as into the respective receiving space of the laminated core of the rotor, in such a way that the respective permanent magnets complement an outer contour of the laminated core and thus the rotor as a whole to form a circular outer contour.

In a further embodiment, the respective circular arc of the circular sector of the respective permanent magnet and the laminated core of the rotor form a circular outer contour in relation to the axis. The permanent magnets embedded in the rotor can therefore follow the outer radius of the rotor with their radially outward-facing side. The side facing outwards is the side that is not inserted into the receiving space or is in contact with the rotor laminated core.

A “circular outer contour” describes the shape of an object whose outer boundary runs in a circular pattern. This means that the outer edge of the object has the same distance from a central point in all directions, so that the shape of the object corresponds to a circle. Manufacturing tolerances should not be taken into account when considering the circular outer contour.

In an implementation, the receiving space is triangular in shape and the respective permanent magnet has a circular sector-like contour, wherein the permanent magnet comprises a first radius and a second radius, wherein the two radii converge to form a tip, which is inserted into the respective receiving space. In an advantageous further embodiment, the tip of the respective permanent magnet can point to the center of the rotor, in such as to the axis. The first radius and the second radius include a center angle α.

Embodiments of the present invention also relate to a high-speed engine according to at least one of the preceding embodiments.

In the following, embodiments of the invention are described by way of example with reference to the drawings.

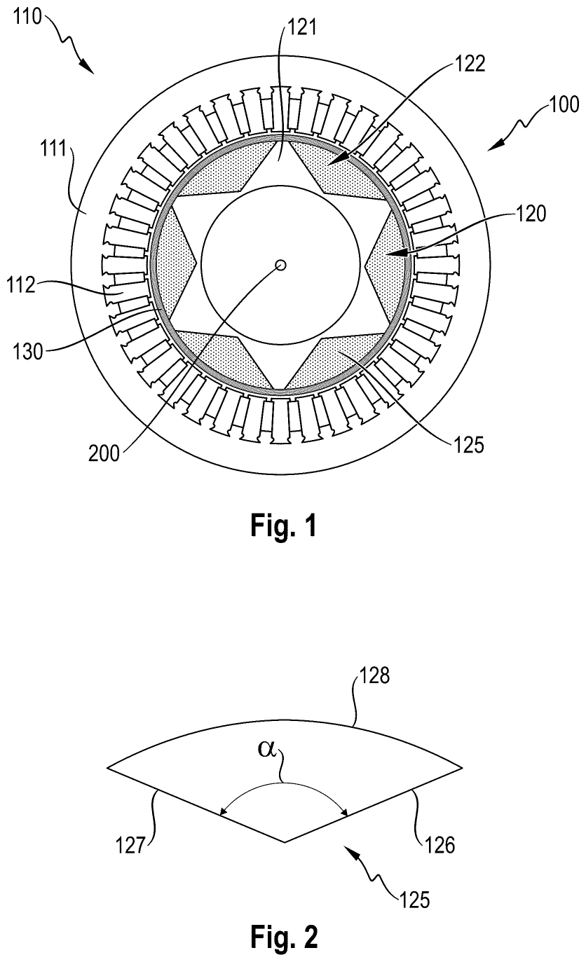

FIG. 1 shows a high-speed engine 100 for a motor vehicle, comprising a stator 110 and a rotor 120 mounted rotatably relative to the stator 110 along an axis 200. The stator 110 comprises a stator yoke 111 and a plurality of stator teeth 112, wherein the stator teeth 112 are connected to the stator yoke 111 in a force-fitting and/or form-fitting manner. The rotor 120 comprises layered electrical steel sheets in the axial direction, which form a laminated core 121, wherein the laminated core 121 comprises at least two receiving spaces 122 in the radial direction to the axis 200, wherein a permanent magnet 125 is arranged in each of the respective receiving spaces 122. The respective permanent magnet 125 is inserted in a force-fitting manner in the respective receiving spaces 122, wherein the laminated core 121 with the permanent magnets has a circular outer contour in the radial direction to the axis 200, wherein the rotor 120 is enclosed by a retaining band 130 for fixing the permanent magnets 125 in the laminated core.

The respective permanent magnet 125 has a circular sector-like contour. The permanent magnet comprises a first radius 126 and a second radius 127, the two radii converging to form a tip. The first radius 126 and the second radius 127 include a center angle α at the tip. The circular sector is a partial area of a circular surface which is delimited by the first radius 126 and a second radius 127 and the circular arc 128 lying between them. The first radius 126 and the second radius 127 are of the same size.

FIG. 2 shows a permanent magnet 125 with a circular sector-like contour. The permanent magnet comprises a first radius 126 and a second radius 127 t, with the two radii converging to form a tip. The first radius 126 and the second radius 127 include a center angle α. The circular sector is a partial area of a circular surface which is delimited by the first radius 126 and a second radius 127 and the circular arc 128 lying between them.

The invention is not limited to the exemplary embodiments described. Within the scope of the invention, all described and/or drawn features can be combined with each other as desired, unless otherwise indicated.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A high-speed engine for a motor vehicle, the high-speed engine comprising:
a stator comprising a stator yoke and a plurality of stator teeth, the plurality of stator teeth being connected to the stator yoke in a force-fitting and/or form-fitting manner; and
a rotor mounted rotatably relative to the stator along an axis, the rotor comprising layered sheets in the axial direction, which form a laminated core,
wherein the laminated core comprises at least two receiving spaces for receiving permanent magnets in a radial direction relative to an axis,
wherein a respective permanent magnet of the permanent magnets is arranged in a respective receiving space of the at least two receiving spaces,
wherein the respective permanent magnet is configured to be inserted in a force-fitting manner in the respective receiving space,
wherein the laminated core with the permanent magnets has a circular outer contour in the radial direction relative to the axis, and
wherein the rotor is enclosed by a retaining band for fixing the permanent magnets in the laminated core.

2. The high-speed engine for the motor vehicle according to claim 1,
wherein the retaining band is configured as a carbon fiber bandage.

3. The high-speed engine for the motor vehicle according to claim 2,
wherein a fiber direction of the carbon fiber bandage extends radially around the rotor.

4. The high-speed engine for the motor vehicle according to claim 1,
wherein the rotor comprises 4 or 6 or 8 receiving spaces each for receiving a permanent magnet.

5. The high-speed engine for the motor vehicle according to claim 1,
wherein a position of the respective receiving space on the rotor can be calculated using the equation,
$${θ}_{n} = \frac{360 °}{2 \cdot p} n$$
where 2*p corresponds to a pole number of the high-speed engine, n corresponds to the consecutive number of the receiving space and θ_n corresponds to the angular position in degrees of the respective receiving space as a function of n.

6. The high-speed engine for the motor vehicle according to claim 5,
wherein the respective permanent magnet is configured as a circular sector.

7. The high-speed engine for the motor vehicle according to claim 6,
wherein a radius of a circular arc of the circular sector corresponds to a radius of the rotor.

8. The high-speed engine for the motor vehicle according to claim 7,
wherein a respective circular arc of the circular sector of the respective permanent magnet and the laminated core of the rotor form the circular outer contour relative to the axis.

9. The high-speed engine for the motor vehicle according to claim 6,
wherein the respective receiving space is triangular in shape and the respective permanent magnet has a wedge-sector-like contour, the respective permanent magnet comprising a first radius and a second radius, the first radius and the second radius converging to form a tip which is configured to be inserted into the respective receiving space.

10. A motor vehicle comprising the high-speed engine according to claim 1.
